(19) United States
(12) Patent Application Publication
(10) Pub. No.: US 2008/0077649 A1
(43) Pub. Date: Mar. 27, 2008

(54) Method and System for Carrying Out Transactions Between Units in a Network

(76) Inventor: Ronald Barker, Munchen (DE)

Correspondence Address: KRIEGSMAN & KRIEGSMAN, 30 TURNPIKE ROAD, SUITE 9, SOUTHBOROUGH, MA, 01772, US

(21) Appl. No.: 10/558,515

(22) PCT Filed: Feb. 17, 2004
(86) PCT No.: PCT/DE04/00292

§ 371 Date: Dec. 28, 2006

(30) Foreign Application Priority Data
May 26, 2003 (DE) 103 23 904.9

(51) Int. Cl. G06F 15/16

(52) U.S. Cl. 709/202

(57) ABSTRACT

A process as well as a system are described for carrying out transactions between units in a network, at least one component of the network being formed by the Internet and at least one unit taking the form of a transaction sender unit and at least one unit taking the form of a transaction receiver unit. In accordance with the invention, it is provided that a direct communication between the transaction sender unit and the transaction receiver unit occurs via the network, whereby, for this purpose, via a position locating method, positional data of the transaction sender unit are automatically produced and are electronically linked to address data assigned uniquely to the transaction sender unit, said address data comprising at least one Internet address, to create a transaction sender unit* that uniquely identifies the transaction sender unit, that the transaction sender files of all transaction sender units are electronically stored in a central file, that, for initiation of a transaction, positional data of the transaction receiver unit are automatically produced via a position locating method, that the positional data of the transaction receiver unit are electronically compared with the transaction sender files from the central file, that the address data of one transaction sender unit or of several transaction sender units that exhibits or exhibit agreement of its or their positional data with the positional data of the transaction receiver unit or at least is or are located in a defined surrounding area in relation to the position of the transaction receiver unit are automatically activated via the transaction receiver unit and, that, when the address data of a transaction sender unit are activated in the transaction receiver unit for carrying out a transaction via the network, a direct communications link between the transaction sender unit and the transaction receiver unit is automatically made. *sic; file?—Trans. Note.

The present invention relates, first of all, to a process for carrying out transactions between units in a network in accordance with the preamble of patent claim 1. The invention further relates to a system for carrying out transactions between units in a network in accordance with the preamble of patent claim 15.

Recently, the operators of mobile networks (mobile network operators, MNOS) have invested very strongly in the next generation of mobile telephone infrastructure, which is known generally as UMTS (universal mobile telecommunications system) (CDMA 2000 in the USA). The UMTS network makes available the broadband frequency spectrum, which is necessary in order to support packet-oriented services. Services of this kind are fundamentally IP-based in layout, which means that these services run under an Internet protocol. At the present time, all services in a mobile wireless network are circuit-switched. The transition from such services—based on circuit-switched data transmission—to packet-oriented services (IP-based services) is the basis of intensive research at the present time.

IP-based services function per se according to the concept of peer-to-peer connections. Each unit (in general, starting from a computer) has a unique Internet address assigned to it, by means of which each unit can be identified. By means of this unique Internet address, each unit can be reached by every other unit through, for example, accessing, addressing, or contacting for communications purposes. However, this original Internet concept, based on the peer-to-peer structure, has been abandoned in favor of another concept, which is known as the client-server concept or the master-slave concept. According to this concept, the units that function as client are not capable of addressing or contacting other units in the network—for example, other computers in the Internet—in a free and independent manner. The reason for the use of such a client-server system reflects, among other things, technical security aspects. Thus, large interdependent networks are very readily exposed to the danger that they can be attacked from the outside, that is, by unauthorized third parties, in that the latter gain unallowed access to the network. Also, it is simpler at the present time to distribute IP-based data packets via a client-server system in a network.

However, the operators of mobile wireless networks need to offer IP-based services. At the present time, this is achieved by means of general packet radio service (GPRS). These IP services continue to be entirely client server—based, however. This is a drawback, though. In the hitherto existing client-server systems, it is not possible to establish a direct communication between two units, as is possible for peer-to-peer systems.

Starting from this, the present invention is based on the problem of providing a process as well as a system for carrying out transactions between units in a network, by means of which, in a simple and nonetheless secure way, a direct communication between two or more units within a network is possible for carrying out transactions.

This problem is solved according to the invention by the process having the features according to the independent patent claim 1 as well as the system having the features according to the independent claim 15. Further advantages, features, details, aspects, and effects of the invention ensue from the subclaims as well as from the description. Features and details therein that are described in connection with the process according to the invention obviously apply as well in connection with the system according to the invention and vice versa.

Provided according to a first aspect of the invention is a process for carrying out transactions between units in a network, at least one component of the network being formed by the Internet and at least one unit taking the form of a transaction sender unit and at least one unit taking the form of a transaction receiver unit. In accordance with the invention, the process is characterized in that, via the network, a direct communication occurs between the transaction sender unit and the transaction receiver unit. For this purpose, it is provided that, via a position locating method, positional data of the transaction sender unit are automatically produced and are electronically linked to address data assigned uniquely to the transaction sender unit, which comprise at least one Internet address, to create a transaction sender file that uniquely identifies the transaction sender unit, that the transaction sender files of all transaction sender units are electronically stored in a central file, that, for initiation of a transaction, positional data of the transaction receiver unit are automatically produced via a position locating method, that the positional data of the transaction receiver unit are electronically compared with the transaction sender files from the central file, that the address data of one transaction sender unit or of several transaction sender units that exhibits or exhibit agreement of its or their positional data with the positional data of the transaction receiver unit or at least is or are located in a defined surrounding area in relation to the position of the transaction receiver unit can be automatically activated or are activated, and that, when the address data of a transaction sender unit are activated in the transaction receiver unit, a direct communications link between the transaction sender unit and the transaction receiver unit is automatically made for carrying out a transaction via the network.

The process according to the invention thus makes it possible to establish a direct communication between a transaction sender unit and a transaction receiver unit, so that transactions between these units can be carried out simply, rapidly, securely and without expense for the user.

In consequence, transactions can then be carried out also in those situations in which an interaction with another party is to take place in real time. Such processes were hitherto not possible, particularly in mobile wireless networks. Now, it is henceforth possible by means of the process according to the invention to carry out IP-based services, with all services being mobilely originated and mobilely terminated.

The process according to the invention can be used, in particular, to fulfill the conditions described below. First of all, the units involved in the transaction, namely, the transaction sender unit and the transaction receiver unit, can be addressed globally. Furthermore, the units can be identified absolutely correctly and unequivocally. Furthermore, a real-time verification of the transaction is possible. The required user interaction is thereby kept as low as possible.

The process according to the invention provides, first of all, that transactions between units in a network are to be carried out, at least one component of the network being formed by the Internet and at least one unit taking the form of a transaction sender unit and at least one unit taking the form of a transaction receiver unit.

A transaction requires, as a rule, at least two units. A “transaction” is understood in light of the present description to be generally an activity that is concluded essentially between two or more units within a network. The invention is not limited here to specific kinds of transactions. For example, a transaction my involve a sales action, in which one participant in the transaction conveys a good or a service to another participant in the transaction for payment of a monetary price. Such an example is discussed in greater detail in the further course of the description, without the invention being limited to this example.

Obviously, then, other kinds of transactions are also conceivable. Thus, it is possible, for example, that, via the transaction, a specific activity is started or executed. For example, it is conceivable that the transaction consists in starting a specific mechanism—for example, opening and closing a garage door or the like. It is equally conceivable that a transaction can be understood to refer to the reading out of sensor elements or the analysis of values measured via a sensor element. It is also conceivable that, via a corresponding transaction, maintenance activities on devices or instruments, which, in such a case, are linked to a transaction sender unit or comprise such a unit, can be carried out. The process according to the invention can be employed in a number of ways for the most diverse kinds of application.

According to the present process, it proceeds between at least one transaction sender unit and at least one transaction receiver unit. A “transaction receiver unit” generally involves a unit that is intended to carry out or to initiate a specific activity. A “transaction sender unit” involves a unit that, in the framework of the activity to be carried out, represents the counterpart of the transaction receiver unit.

In accordance with the invention, it is provided that the process takes place in a network. Such a network can also consist of diverse subnetworks, which act together at least part of the time and/or at least to a partial extent. Here, one part of the network represents the Internet. The other subnetwork of the network can involved, for example, a mobile wireless network, this mobile wireless network taking the form, in particular, of a UMTS network. In this case, at least individual steps of the transaction process proceed via the mobile wireless network.

When a subnetwork of the network takes the form of a UMTS network, such a network disposes over a control level, by means of which a unit-to-unit direct control and thus a peer-to-peer connection is possible.

Especially preferably, therefore, the network comprises a mobile wireless network component as well as an Internet component.

In accordance with the invention, it is henceforth provided that a direct communication between the transaction sender unit and the transaction receiver unit occurs. To this end, it is provided, first of all, that, via a position locating method, positional data of the transaction sender unit are automatically produced and are electronically linked to address data assigned uniquely to the transaction sender unit to create a transaction sender file that uniquely identifies the transaction sender unit. Here, the address data assigned to the transaction sender unit comprise at least one Internet address. Obviously, it can be provided that the address data comprise other types of data as well.

What is involved in this basic process step is the creation of a file that identifies the transaction sender unit uniquely and unequivocally. This is accomplished, on the one hand, via individual address data of the transaction sender unit. On the other hand, these address data are linked to positional data. The invention is not thereby limited to specific processes in terms of how this positional data can be determined or produced. In the further description, several, non-exclusive examples of suitable position locating methods are described.

The transaction sender files of all transaction sender units created in this way are electronically stored in a central file. In this way, the data of all transaction sender units can be retrieved in a simple way. However, the invention is not thereby limited to a specific location where the central file is stored. This ensues rather from the prevailing circumstances.

For example, it is conceivable that the network has at least one central computing unit (a so-called server unit), the central file being stored in the central computing unit. In another embodiment, it is also conceivable that the central file is stored in a computing unit within the transaction receiver unit.

In accordance with the invention, it is provided for initiating a transaction that, via a position locating method, positional data of the transaction receiver unit are automatically produced and are subsequently compared electronically with the transaction sender files from the central file.

When, then, there arises an agreement of the positional data of a transaction sender unit with the positional data of a transaction receiver unit or else when a transaction sender unit is located at least in a defined surrounding area in relation to the position of the transaction receiver unit, the address data of those transaction sender units that exhibit a corresponding agreement are automatically activated.

It can be provided advantageously that the address data of one transaction sender unit or of several transaction sender units that exhibits or exhibit agreement of its or their positional data with the positional data of the transaction receiver unit or at least is or are located in a defined surrounding area in relation to the position of the transaction receiver unit can be automatically displayed or are displayed on the transaction receiver unit.

When a transaction receiver unit approaches a transaction sender unit, for example, the address data of this transaction sender unit are automatically transmitted to the transaction receiver unit once the transaction receiver unit has reached a specific proximity to the transaction sender unit.

Once the address data of the transaction sender unit has been displayed and activated on the transaction receiver unit, a direct communications link is automatically made between the transaction sender unit and the transaction receiver unit for carrying out a transaction via the network. This can occur in the most diverse ways, so that the invention is not limited to the creation of specific communications links. When, for example, the transaction involves a sales action, an offer can be transmitted, for example, to the transaction receiver unit from the transaction sender unit after a communications link has been created. It is equally conceivable that, after the communications link is made, an execution order is transmitted from the transaction receiver unit to the transaction sender unit—for example, to open a garage door or the like. It is also conceivable that, after the direct communications link is made, information data in the form of signal values or the like are transmitted from the transaction sender unit to the transaction receiver unit. This can happen, for example, in the case when sensor elements or the like are to be read out.

As already discussed further above, the network can have, for example, at least one central computing unit, the central file being stored in the central computing unit. In such a case, the positional data of the transaction receiver unit can be transmitted to the central computing unit and compared there with the transaction sender file from the central file. Address data of those transaction sender units that exhibit an agreement of their positional data with the positional data of the transaction receiver unit or that are at least in a defined surrounding area in relation to the position of the transaction receiver unit are then automatically transmitted to the transaction receiver unit and displayed there. In such a case, the central computing unit can involve, for example, a server unit, which is assigned to the network operator or to the operator of the subnetwork. When a subregion of the network involves a mobile wireless network, the central computing unit can be assigned, for example, to the mobile wireless network operator. The latter then has the possibility of offering his customers the carrying out of transactions as a special service.

In another embodiment, it can be provided that the central file is stored in a computing unit within the transaction receiver unit. In such a case, the positional data of the transaction receiver unit are compared in this computing unit with the transaction sender files or with the positional data of the transaction sender unit from the central file. When there occurs an agreement with the positional data or else when the transaction receiver unit¹ is located at least in a defined surrounding area in relation to the position of the transaction receiver unit, the address data of those transaction sender units are automatically displayed on the transaction receiver unit. In this case, the transaction receiver units preferably have special means that enable an access to the transaction procedure offered by the network operator. Such means can involve, for example, suitable program means or the like. ¹ [Translator's Note] sic

Advantageously, it is provided that address data are also assigned uniquely to the transaction receiver unit and that, after a direct communications link has been created, information data is automatically transmitted from the transaction sender unit to the address data of the transaction receiver unit. The address data can involve, for example, telephone numbers for transmission of SMS messages or the like. The address data can also comprise—as was already described further above in connection with the transaction sender unit—at least one Internet address.

Advantageously, it can be provided that the information data are transmitted from the transaction sender unit to the transaction receiver unit in the form of a webpage.

In another embodiment, it can be provided that the address data of those transaction sender units that exhibit an agreement of their positional data with the positional data of the transaction receiver unit or that are located at least in a defined surrounding area in relation to the position of the transaction receiver unit are displayed in the form of a webpage on the transaction receiver unit.

In the cases described above, it is especially advantageous when the address data of the transaction receiver unit comprise an Internet address.

In particular, it is advantageous that the Internet addresses comprised by the address data of the transaction sender unit and/or the transaction receiver unit take the form of Internet addresses created according to the IPv6 standard. This IPv6 standard makes it possible for each unit to have its own personal and unique Internet address. When the network comprises, for example, the UMTS network, these Internet addresses are already inherently taken into consideration in the network.

The IPv6 Internet protocol involves a transport protocol, which transports individual packets through a network. Each data packet is thereby transmitted through the network fully independently, in principle, of preceding or following ones. The IPv6 protocol disposes over 128-bit-long addresses, this meaning that an inconceivable number of IP addresses are obtainable.

Preferably, it can be provided that the transaction sender unit and/or the transaction receiver unit has a means for encrypting and/or decrypting data and that, during a communication procedure, at least portions of the transaction data are transmitted at least temporarily encrypted between the transaction sender unit and the transaction receiver unit. In this way, a secure communication or a secure exchange of data is ensured, without unauthorized parties being able to access these data or this data exchange.

In a further embodiment, it can be provided that transaction data produced by the transaction receiver unit and/or by the transaction sender unit are electronically verified within an authentication instance. The authentication instance has, in particular, the function of checking that the unit transmitting the transaction data indeed actually involves the unit that it identifies itself as. Such authentication instances and the authentication and electronic verification of information data are in themselves already known. For this reason, the invention is not limited to specific embodiments of the authentication instance.

For example, it can be provided that the authentication instance is a component of the network, the transaction data being transmitted from the transaction receiver unit via the network to the authentication instance and being verified there, and that the verified transaction data are transmitted subsequently from the authentication instance to the transaction sender unit. Naturally, in the same way, it is also possible for data that is transmitted from the transaction sender unit to the transmitter receiver unit to be verified. In another embodiment, it is conceivable that the authentication instance is a component of the transaction sender unit and that the transaction data are transmitted from the transaction receiver unit via the network to the authentication instance and verified there.

Provided in accordance with a second aspect of the invention is a system for carrying out transactions between units in a network, at least one component of the network being formed by the Internet and at least one unit taking the form of a transaction sender unit and at least one unit taking the form of a transaction receiver unit. In accordance with the invention, the system is characterized in that it has means for carrying out the process according to the invention described above.

In particular, it is provided that a component of the network takes the form of a mobile wireless network, in particular a UMTS network.

Advantageously, it is provided that at least one transaction sender unit takes the form of a stationary unit. However, it is also possible that at least one transaction sender unit takes the form of a mobile unit. The basis is indeed that the positional data of the transaction sender unit are linked to the address data thereof. When the position locating method is set up in such a way that it can determine the position of mobile units, the transaction sender units can also be designed to be mobile.

Advantageously, at least one transaction receiver unit takes the form of a mobile unit. The invention is not thereby limited to specific types of mobile units. For example, the transaction receiver unit can involve a portable computer, like a laptop, a personal digital assistant (PDA), or the like. When the network also comprises a mobile wireless network, the mobile unit can also preferably involve a mobile telephone.

Advantageously, the network can have at least one central computing unit. In such a central computing unit, which, for example, can take the form of a server unit, the central file can then be deposited, for example. In a further embodiment, it is conceivable that the transaction receiver unit and the transaction sender unit have a computing unit. All of the procedures relating to the transaction can run via this computing unit. In particular, it is also conceivable that the central file is deposited on such a computing unit.

Preferably, it can be provided that the transaction receiver unit and/or the transaction sender unit has a means for positional location of the unit. The invention is not thereby limited to specific means for positional location. It is only important that a position locating method can be carried out by the means and, in this way, the positional data of the transaction sender unit and/or the transaction receiver unit can be produced. Some non-exclusive examples for suitable means for positional location are described below. Thus, it is conceivable, for instance, that the means for positional location comprise a terrestrial module and/or a wireless module.

When a terrestrial module is used, it is possible, for example, to determine the positional data of the units by means of a satellite-based global positioning system (GPS).

For positional location by means of a wireless module, recourse can be had, for example, to a system or method for locating mobile end devices. Various solutions have already become known in this regard. Thus, in DE 198 03 960, the disclosure of which is insofar incorporated into the description of the present invention, is a process and system for utilizing modern locating systems in mobile wireless systems. The locating of a mobile telephone can, for example, occur also according to the so-called EOTD (enhanced observed time difference) method. In it, the different times it takes for signals of a mobile telephone to reach several transmitters are measured. Suitable algorithms can then be used to determine automatically from the measured values the location of the mobile telephone.

Preferably, it can be provided here that the central computing unit has means for positional location of the transaction receiver unit and/or the transaction sender unit.

Especially preferably, it is provided that the transaction sender unit and the transaction receiver unit have means for supporting the IPv6 Internet protocol.

It can be further provided that the transaction sender unit and the transaction receiver unit each have a communications module, which is designed for a direct access to the Internet. What can be involved here is, in particular, a module that supports wireless access to the Internet—for example, WLAN, GSM, GPRS, and/or UMTS.

In a further embodiment, it can be provided that at least one authentication instance is provided in the network and that the authentication instance is designed for verification of the transmitted transactions. Here, it can be provided, for example, that the authentication instance takes the form of an independent component in the network. It is equally conceivable that the authentication instance takes the form of a component part of the transaction receiver unit and/or the transaction sender unit.

Advantageously, the transaction sender unit and the transaction receiver unit can have means for encrypting and/or decrypting data. What can be involved here, for example, is a security module, with the aid of which asymmetric and/or symmetric encryption/-decryption procedures can be carried out. In particular, when a portion of the network takes the form of a UMTS network and individual units take the form of mobile telephones, these mobile telephones have a means for intelligent encryption/decryption of transmitted data.

In a further embodiment, the transaction sender unit and/or the transaction receiver unit can have a display device for the visual display of information. What can be involved here is, for example, a suitable interface, like a display monitor, a touch screen, or the like.

Finally, it can be provided that the transaction sender unit has signal means and that the signal means are designed for indicating a direct communication between the transaction sender unit and the transaction receiver unit. In this way, the user of a transaction receiver unit can be signaled by the transaction sender unit when a direct communications link has been made between the transaction receiver unit and the transaction sender unit. To this end, the signal means are designed, for example, for optical or acoustic signals. Optical signals can be produced, for example, by means of a lamp, by means of a display of text messages, and the like.

A preferred system by means of which the process according to the invention can be carried out has, for example, a computing unit, which disposes over the following features: A) adequate resources to operate a real-time operating system (RTOS) and B) to ensure that the RTOS is capable of supporting a communications module, which, in turn, supports the IPv6 Internet protocol, C) a localization possibility in the form, for example, of a GPS receiver (global position satellite receiver), which is integrated into the unit or units, D) a communications module, which enables, in particular, wireless access to the Internet, E) a security module, which supports asymmetric and/or symmetric encryption/decryption procedures, F) a display device for displaying the transaction course, such as one for displaying its termination, its confirmation, or its postponement, G) program means in the form of an application, which make it possible to convert over to the protocol standards for World Wide Web access, and H) program means that implement a JAVA virtual machine.

In particular, therefore, the process according to the invention as well as the system according to the invention can be employed especially advantageously because the following components are realized in the network or in the transaction receiver units and the transaction sender units. First of all, a flexible IP address scheme exists for all participants. This address scheme includes the dynamic production of globally selectable IP addresses, an adequate number of IP addresses for all units involved, and a simple automatic routing as well as an integrated security concept.

Furthermore, a dynamic decision of the transaction sender unit for a transaction receiver unit that is located in its surroundings is possible. This means that, also in those cases in which several transaction sender units are located in the immediate surroundings of a transaction receiver unit, it is always possible to establish uniquely, via the transaction receiver unit, with which of the transaction sender units the direct communications link has been created.

Furthermore, the present invention makes it possible to create a direct, secure communications link between the transaction sender units and the transaction receiver units without the necessity of the interaction of a content server or a service provider.

Moreover, it is not necessary for the user of the transaction receiver unit to enter into an extensive dialogue with the transaction sender unit, which hitherto not seldom involved a complex sequence of individual operating steps.

Finally, it is henceforth possible in an especially simple way to authenticate and to verify the transmitted transaction data.

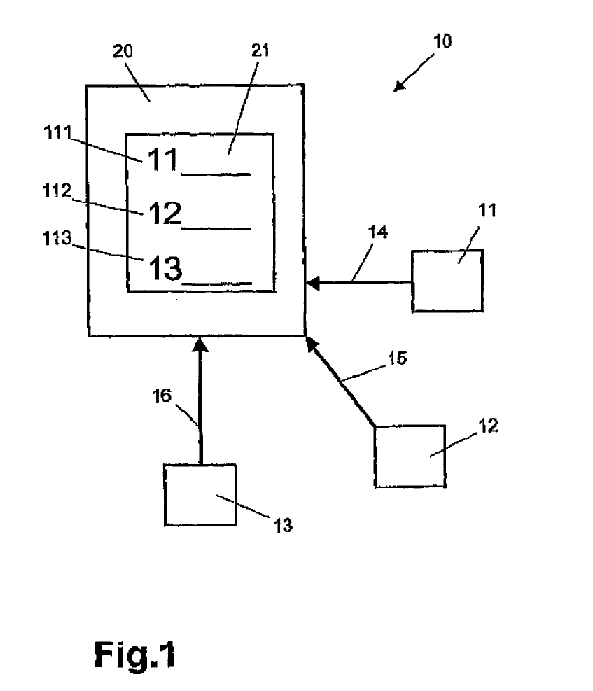

In the following, the invention will be explained in more detail on the basis of a concrete embodiment example with reference to the attached drawings. In them, FIGS. 1 to 3 represent the principal process course of a transaction in accordance with the present invention within a system according to the invention.

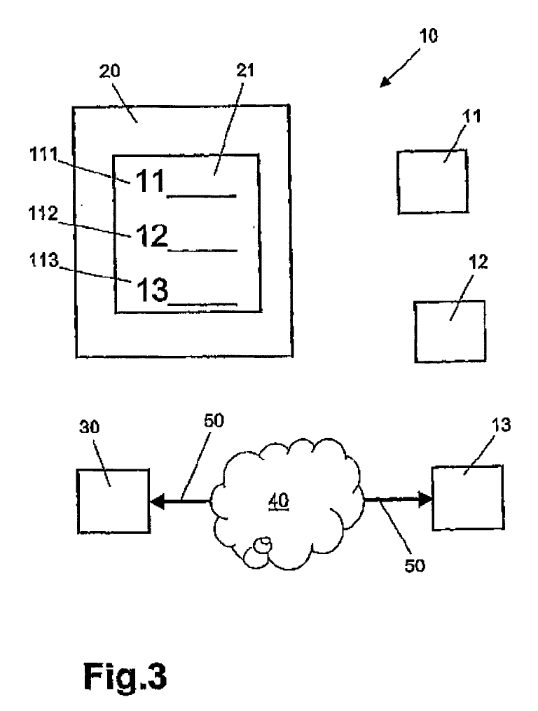

The embodiment example relates to a transaction between a transaction receiver unit 30, taking the form of a mobile telephone, and an automated anonymous unit, for which is involved a transaction sender unit 11, 12, 13—for example, a vending machine. The transaction is to take place in a system 10, which, among other things, has a network. A portion of the network is formed here by the Internet 40 (FIG. 3). Another component of the network is formed by a mobile wireless network—for example, the UMTS network. The transaction is to consist in the fact that, via the transaction receiver unit 30, goods or services—goods in the present case—are procured from the transaction sender unit 11, 12, 13.

In accordance with the invention, then, it is possible that the mobile telephone 30 (transaction receiver unit) and the vending machine 13 (transaction sender unit) communicate with each other directly via the Internet 40 (FIG. 3) in order to establish the conditions for the transaction, which consists of the sale of and the payment for a specific item from the vending machine 13. To this end, in accordance with the invention, it is possible for the mobile telephone 30 to be linked to the Internet 40 via a static, globally selectable address. Likewise, the vending machine 13 can be linked to the Internet 40 through a static, globally selectable address. The mobile telephone 30 has the capability of determining the address of the vending machine 13. Furthermore, the vending machine 13 has the possibility of authenticating or of having authenticated the transaction data transmitted by the mobile telephone 30.

In order to be able to carry out the transaction, the transaction sender unit 13, taking the form of a vending machine, can be furnished additionally with suitable means by which the goods selected via the transaction receiver unit 30 (the mobile telephone) can also be physically delivered. What can be involved here are, for example, suitable program means, which are implemented within the vending machine 13. Furthermore, the vending machine 13 can dispose over mechanical and electronic actuators, switches, switch components, and the like, which, in particular, are placed under the control of a computing unit and the program means and which serve to transport the selected goods to a dispensing point of the vending machine 13 and to dispense them at this point.

Furthermore, the transaction receiver unit 30 can be equipped with a suitable interface, such as, for example, a touch screen, a keypad, or the like. Via this interface, the user of the transaction receiver unit 30 is enabled to begin the transaction, to confirm it, to postpone it, or to terminate it.

In order to offer such a transaction service, it is necessary, first of all, to ensure that the transaction sender units 11, 12, 13 are linked to a static, globally addressable Internet address—for example, an IPv6 address (FIG. 1). The Internet addresses are subsequently linked to the actual geographic coordinates of the transaction sender units 11, 12, 13, which are determined via a position locating method. The totality of these data constitute the transaction sender file 111, 112, 113. This Internet address (IPv6 address) as well as the positional data uniquely determine the transaction sender unit 11, 12, 13. This information (the transaction sender file 111, 112, 113) is stored in a central file 21.

In the present example according to FIG. 1, the transaction sender files 111, 112, 113 are first produced in the transaction sender units 11, 12, 13 and subsequently transmitted to the central computing unit 20, which is a component of the system 10, this being indicated by the arrows 14, 15, and 16. It is equally conceivable that the transaction sender files 111, 112, 113 are produced within the central computing unit 20.

The network operator can supply the transaction sender unit 11, 12, 13 with an application specification for a specific platform, on which the transaction sender unit 11, 12, 13 runs. This specification can provide, for example, that the application A) runs as WWW server, which provides an HTML page on which the selection possibilities for the transaction receiver are displayed. Furthermore, it is necessary, first of all, to establish the relation of the ordered goods and the manipulation of the transaction sender unit 11, 12, 13, so that these goods can be delivered. B) Furthermore, the application can run as a specific IP service, which uses a specific protocol in order to carry out the transaction.

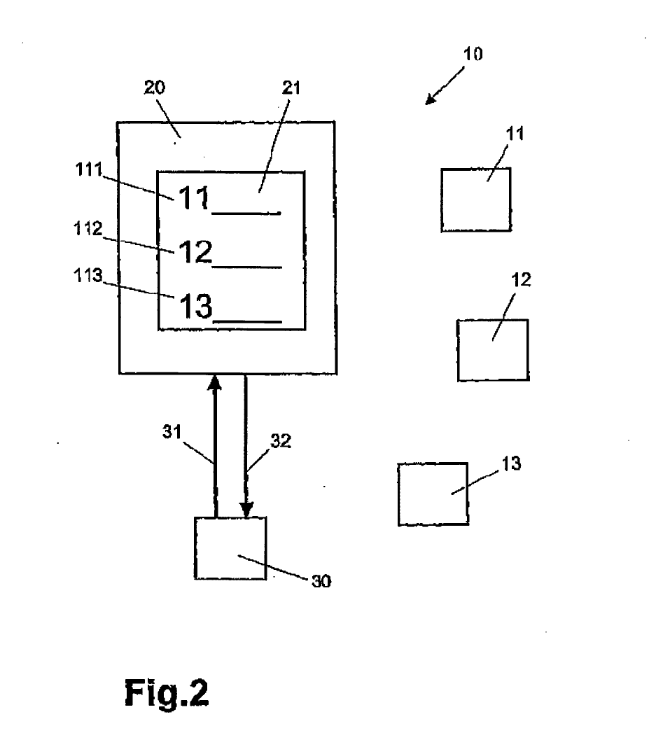

According to FIG. 2, for carrying out a transaction, the position of the transaction receiver unit 30 that is permitted to carry out the transaction is determined. The positional data determined in this way can be made available to corresponding program means, via which a localization of the transaction sender units 11, 12, 13 can be initiated. These program means can be deposited as a file, for example, in the transaction receiver unit 30. When the user of a transaction receiver unit 30 wishes to start a transaction with a transaction sender unit 11, 12, 13, a corresponding request, based on the current position of the transaction receiver unit 30, can be transmitted to a central computing unit 20, this being indicated by the arrow 31. This central computing unit 20 can involve, for example, a WWW server, which is kept ready and operated by the network operator. In the central computing unit 20, the positional data of the transaction receiver unit 30 are compared with the positional data of the transaction sender units 11, 12, 13. Insofar as a predetermined agreement is established, either in that the positional data are in agreement or else in that the positional data of the transaction sender units 11, 12, 13 lie within an established periphery in relation to the transaction receiver unit 30, the address data of those transaction sender units—in the present example, the address data of the transaction sender unit 13—are transmitted to the transaction receiver units 30. Here, all of those transaction sender units 13 that are located within a specific radius around the transaction receiver unit 30 are displayed. The central computing unit 20—for example, the WWW server—transmits the corresponding information subsequently to the transaction receiver unit 30, this being indicated by the arrow 32. This can occur, for example, by means of a website with HTML links to those computing units that are located in the transaction receiver units 13 within a specific radius around the transaction sender unit 30. It is equally conceivable that specific JAVA applications, which run under the protocol of the transaction sender unit(s) 13 located within the specific radius, are downloaded in the transaction receiver unit 30.

In each case, a direct access is achieved to the transaction sender unit(s) 13 either through the WWW browser or the JAVA application. This happens by means of the globally accessible Internet address—for example, the IPv6 address—of the transaction sender unit 13.

In the case of a Web browser interface, the user will activate on his transaction receiver unit 30 the Internet address (URL) of that transaction sender unit 13 from which he wishes to procure goods or services. The transaction sender unit 13 is contacted directly via the Internet 40, represented by the communications link 50, and transmits information data in the form, for example, of a website, to the transaction receiver unit 30 (see FIG. 3). This information data contains the available selection of goods, the prices, and any other information that is required in order to carry out the transaction. In the case of a JAVA application, the user of the transaction receiver unit 30 activates this application and the information data required for the transaction are presented on the transaction receiver unit 30 in accord with the specifications of the protocol of the transaction sender unit 13.

An optical signal means—for example, an LED indicator or a back-lighted text display field or the like—can be advantageously activated for the transaction sender unit 13 in order to indicate to the user that his transaction receiver unit 30 is indeed actually communicating with the desired transaction sender unit 13. Then, via the transaction receiver unit 30, the actual transaction phase can be initiated and carried out in that, for example, a corresponding selection of goods is made and it is subsequently confirmed that the desire for continuation of the transaction indeed exists as well. This can occur, for example, through operating corresponding keys of a keypad, through touching specific surfaces on a touch screen, and the like.

Once the selection procedure has been ended, the purchase price to be paid is determined in the transaction sender unit 13, preferably automatically, and subsequently made known to the user of the transaction receiver unit 30. This can occur, for example, through transmission onto the transaction receiver unit 30 and/or through display on a corresponding display device of the transaction sender unit 13. The confirmation of this price starts a verification procedure. First of all, to this end, the transaction sender unit 13 requests an authorization of the transaction receiver unit 30 for receipt of the selected goods. This request can include, for example, an Internet address, such as, for instance, an IPv6 address of such an acceptance instance, which carries out and monitors the payment operation. The transaction receiver unit 30 electronically produces such an authorization regarding the purchase price to be paid. This authorization can be signed for purposes of encryption with the private key of the transaction receiver unit 30 and is subsequently transmitted to an authentication instance, where the integrity of the authorization is verified. The key used for this can be produced at an earlier point in time and provided to the user of the transaction receiver unit 30 by, for example, implementing it in the transaction receiver unit 30.

The authorization for collection of the outstanding monetary amount can contain, at the same time, the Internet address of the transaction sender unit 13. After checking of the information, the authentication instance transmits corresponding information data to the transaction sender unit 13 so that the latter can dispense the selected goods. The transaction sender unit 13 transmits a purchase receipt to the transaction receiver unit 30, which can be signed with the private key of the transaction sender unit. A copy of the receipt file is transmitted to the acceptance instance, which correlates the selection authorization with the purchase proof and automatically produces a purchase invoice.

The way in which the transaction is carried out is an implementation detail that ensues depending on the kind and quality of the offered goods or services. Advantageously, the acceptance instance and/or the authentication instance can also be a component part of the central computing unit 20.

1. A process for carrying out transactions between units in a network, at least one component of the network being formed by the Internet and at least one unit taking the form of a transaction sender unit and at least one unit taking the form of a transaction receiver unit, characterized
in that a direct communication between the transaction sender unit and the transaction receiver unit occurs via the network;
in that, for this purpose, via a position locating method, positional data of the transaction sender unit are automatically produced and are electronically linked to address data assigned uniquely to the transaction sender unit, said address data comprising at least one Internet address, to create a transaction sender file that uniquely identifies the transaction sender unit;
in that the transaction sender files of all transaction sender units are electronically stored in a central file;
in that, for initiation of a transaction, positional data of the transaction receiver unit are automatically produced via a position locating method;
in that the positional data of the transaction receiver unit are electronically compared with the transaction sender files from the central file;
in that the address data of one transaction sender unit or of several transaction sender units that exhibits or exhibit agreement of its or their positional data with the positional data of the transaction receiver unit or at least is or are located in a defined surrounding area in relation to the position of the transaction receiver unit can be automatically activated or are activated via the transaction receiver unit; and
in that, when the address data of a transaction sender unit are activated in the transaction receiver unit for carrying out a transaction via the network, a direct communications link between the transaction sender unit and the transaction receiver unit is automatically made.

2. The process according to claim 1, further characterized in that the address data of one transaction sender unit or of several transaction sender units that exhibits or exhibit agreement of its or their positional data with the positional data of the transaction receiver unit or at least is or are located in a defined surrounding area in relation to the position of the transaction receiver unit can be automatically displayed or are displayed on the transaction receiver unit.

3. The process according to claim 2, further characterized in that the network has at least one central computing unit, that the central file is stored in the central computing unit, that the positional data of the transaction receiver unit are transmitted to the central computing unit and electronically compared there with the transaction sender files from the central file, and that the address data of those transaction sender units that exhibit agreement of their positional data with the positional data of the transaction receiver unit or at least are located in a defined surrounding area in relation to the position of the transaction receiver unit can automatically be transmitted to the transaction receiver unit and displayed there.

4. The process according to claim 2, further characterized in that the central file is stored in a computing unit within the transaction receiver unit, that the positional data of the transaction receiver unit in the computing unit are compared with the transaction sender files from the central file, and that the address data of those transaction sender units that exhibit agreement of their positional data with the positional data of the transaction receiver unit or at least are located in a defined surrounding area in relation to the position of the transaction receiver unit, are automatically displayed on the transaction receiver unit.

5. The process according to claim 1, further characterized in that address data are assigned uniquely to the transaction receiver unit and that, after a direct communications link has been created, information data of the transaction sender unit are automatically transmitted to the address data of the transaction receiver unit.

6. The process according to claim 5, further characterized in that the information data are transmitted from the transaction sender unit to the transaction receiver unit in the form of a website.

7. The process according to claim 1, further characterized in that the address data of those transaction sender units that exhibit agreement of their positional data with the positional data of the transaction receiver unit or at least are located in a defined surrounding area in relation to the position of the transaction receiver unit are displayed on the transaction receiver unit in the form of a website.

8. The process according to claim 5, further characterized in that the address data of the transaction receiver unit comprise an Internet address.

9. The process according to claim 1, further characterized in that the Internet addresses comprised by the address data of the transaction sender unit and/or the transaction receiver unit take the form of Internet addresses according to the IPv6 standard.

10. The process according to claim 1, further characterized in that the transaction sender unit and/or the transaction receiver unit has a means for encrypting and/or decrypting data and that, during a communication procedure between the transaction sender unit and the transaction receiver unit, at least portions of the transaction data are transmitted at least temporarily encrypted.

11. The process according to claim 1, further characterized in that transaction data produced by the transaction receiver unit and/or by the transaction sender unit are electronically verified within an authentication instance.

12. The process according to claim 11, further characterized in that the authentication instance is a component of the network, in that the transaction data are transmitted from the transaction receiver unit via the network to the authentication instance and are verified there, and that the verified transaction data are transmitted subsequently from the authentication instance to the transaction receiver unit.

13. The process according to claim 11, further characterized in that the authentication instance is a component of the transaction sender unit and that the transaction data are transmitted from the transaction receiver unit via the network to the authentication instance and are verified there.

14. The process according to claim 1, further characterized in that this component of the network involves a mobile wireless network, in particular the UMTS network, and in that at least individual steps of the transaction process proceed via the mobile wireless network.

15. A system for carrying out transactions between units in a network, at least one component of the network being formed by the Internet and at least one unit taking the form of a transaction sender unit and at least one unit taking the form of a transaction receiver unit, characterized in that the system has means for carrying out the process according to claim 1.

16. The system according to claim 15, further characterized in that a component of the network takes the form of a mobile wireless network, in particular a UMTS network.

17. The system according to claim 15, further characterized in that at least one transaction sender unit takes the form of a stationary unit.

18. The system according to claim 15, further characterized in that at least one transaction receiver unit takes the form of a mobile unit.

19. The system according to claim 15, further characterized in that the network has at least one central computing unit.

20. The system according to claim 15, further characterized in that the transaction receiver unit and/or the transaction sender unit has a computing unit.

21. The system according to claim 15, further characterized in that the transaction receiver unit and/or the transaction sender unit has means for positional location of the unit.

22. The system according to claim 21, further characterized in that the means for positional location comprise a terrestrial module and/or a wireless module.

23. The system according to claim 19, further characterized in that the central computing unit has means for positional location of the transaction receiver unit and/or of the transaction receiver unit.

24. The system according to claim 15, further characterized in that the transaction sender unit and the transaction receiver unit have means that support the IPv6 Internet protocol.

25. The system according to claim 15, further characterized in that the transaction sender unit and the transaction receiver unit each have a communications module that is designed for a direct access to the Internet.

26. The system according to claim 15, further characterized in that at least one authentication instance is provided in the network and that the authentication instance is designed for verification of the transmitted transaction data.

27. The system according to claim 26, further characterized in that the authentication instance is designed as an independent component in the network.

28. The system according to claim 26, further characterized in that the authentication instance is designed as a component of the transaction receiver unit and/or the transaction sender unit.

29. The system according to claim 15, further characterized in that the transaction sender unit and the transaction receiver unit have means for encrypting and/or decrypting data.

30. The system according to claim 15, further characterized in that the transaction sender unit and/or the transaction receiver unit have a display device for the visual representation of information.

31. The system according to claim 15, further characterized in that the transaction sender unit has signal means and that the signal means are designed for making known a direct communication between the transaction sender unit and the transaction receiver unit.
